(19) United States
(12) Patent Application Publication
(10) Pub. No.: US 2008/0289245 A1
(43) Pub. Date: Nov. 27, 2008

(54) Artificial Bait for Attracting Fish, and Apparatus and Method of Manufacturing the Same

(76) Inventor: Kwang-Yull Yun, Incheon (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/158,735

(22) PCT Filed: Jul. 12, 2007
(86) PCT No.: PCT/KR2006/005674

§ 371 Date: Jun. 23, 2008

(30) Foreign Application Priority Data
Dec. 27, 2005 (KR) 10-2005-0130163
Jul. 12, 2006 (KR) 10-2006-0065350

(51) Int. Cl. A01K 97/04

(52) U.S. Cl. 43/42.06; 99/484; 426/1

(57) ABSTRACT

The present invention relates to artificial bait, and an apparatus and method for manufacturing artificial bait. In particular, the present invention relates to artificial bait that can maintain the characteristic of attracting fish without replacing, retain the scent over a long period of time and be manufactured with high productivity without the need to dry, and prevent the devastation of a marine ecosystem by not using a natural bait, and an apparatus and method for manufacturing the artificial bait. The apparatus for manufacturing artificial bait includes a mixing unit, a kneading unit, a cooling part, an extrusion unit, and a vacuum part. The apparatus for manufacturing artificial bait mixes artificial scent with loess, and then mixes mix gum in the mixture of the loess and artificial scent. The apparatus mixes a bonding agent in the mixture of the loess, artificial scent, and the mix gum, and then kneads the bonding agent and the mixture. After that, the apparatus extrudes the mixture below a predetermined temperature, and then vacuum-packs an extruded material to manufacture artificial bait.

### TECHNICAL FIELD

The present invention relates to artificial bait, and an apparatus and method for manufacturing the artificial bait. In more particular, the present invention relates to artificial bait that can maintain the characteristic of attracting fish without having to be replaced, retains scent over a long period of time and be manufactured with high productivity without the need to dry, and prevent the devastation to a marine ecosystem without using a natural bait, and an apparatus and method for manufacturing the artificial bait. The apparatus for manufacturing artificial bait includes a mixing unit, a kneading unit, a cooling part, an extrusion unit, and a vacuum part. The apparatus for manufacturing artificial bait mixes artificial scent with loess, and then mixes mix gum in the mixture of the loess and artificial scent. The apparatus mixes a bonding agent in the mixture of the loess, artificial scent, and the mix gum, and then kneads the bonding agent and the mixture. After that, the apparatus extrudes the mixture below a predetermined temperature, and then vacuum-packs an extruded material to manufacture artificial bait.

### BACKGROUND ART

Various methods using tools such as dragnets, reels and lines with multiple hooks, or fish pots have been used as a method of catching fish and shellfish near the coasts of the mainland. However, tools such as dragnets damage the seabed and seaweed, and as a result, a marine ecosystem is devastated. Further, the reels and lines with multiple hooks limit the number of fish caught at one time, and are usually used to catch specific type of fish, such as cuttlefish. In contrast, the fish pots can catch many fish as long as the number of fish pots is increased. Further, the fish pots are environmental friendly. For this reason, the fish pots have been widely used in catching various types of fish species.

The method using fish pots is performed in a manner in which bait for attracting fish and shellfish are put into fish pots, and the fish pots are attached to a long rope and soaked in seawater. In this case, natural bait such as anchovy, mackerel, or sardine is used as the bait. Fish, which are frozen and stored to prevent the transformation or decomposition thereof, are generally used as the natural bait. For this reason, there is a problem in that it is difficult to cut the natural bait into appropriate sizes. In addition, when a fishing boat is rolled due to large waves, it is more difficult to cut the natural bait into appropriate sizes. Further, as time goes by, the particular scent, which attracts fish and shellfish, of the natural bait disintegrates very quickly when soaked in seawater. For this reason, there is a problem in that the amount of catch of fish is significantly decreased. In addition, the natural bait uses caught fish, particularly fries, in fishing. Accordingly, there are problems in that a marine ecosystem is devastated and the amount of catch of fish is decreased over the long term.

Meanwhile, artificial bait for attracting fish has been disclosed in Korean Patent No. 10-0232239. According to the artificial bait for attracting fish, an attraction causative agent group is mixed in a bait holding agent group, and the mixture thereof is manufactured to have the shape of a thin noodle or a grain. Then, the mixture is dried and then packed, so that artificial bait is manufactured. In this case, natural fish such as an anchovy, mackerel, and sardine, or processed by-products or boiled extract of fish and shellfish are used as the attraction causative agent group. However, when natural fish are used as the attraction causative agent group, the following problems occur, as mentioned above. In the case when the processed by-products or boiled extract of fish and shellfish are used as the attraction causative agent group, gills, internal organs, fins, and the like are used instead of fish. For this reason, the particular scent of the bait is significantly reduced. As a result, there is a problem in that the amount of catch of fish is significantly decreased. In addition, since the by-product or boiled extract is obtained from fries, it is not possible to protect fish resources and a marine ecosystem. Further, if the by-products are used as the bait, it is impossible to maintain freshness of the bait. For this reason, the bait undergoes a vacuum freeze-drying process. As a result, there are problems in that the manufacturing cost of the bait is increased and it is difficult to cut the bait into an appropriate size.

Meanwhile, according to the Korean Patent No. 10-0232239, any one selected from a wheat flour, loess, gelatin, devil's-tongue jelly, and starch has been used as the bait holding agent group. As temperature rises, gelatin among them is denatured. Then, when being cooled, the gelatin coagulates. That is, the gelatin is reformed. It is difficult to regularly form the bait in a desired shape due to the denaturation, and the resolutive and dispersive properties of the bait deteriorate due to the coagulation. As a result, there is a problem in that the attraction causative agent group is not smoothly dispersed in seawater. Further, since being a protein ingredient extracted from the bones or muscles of cattle, the gelatin is not suitable for the bait due to bovine spongiform encephalopathy. In addition, there is a problem in that impurities for repelling fish and shellfish may be included in the bait.

### DISCLOSURE

### Technical Problem

The field of artificial bait has infinite possibilities, and the above-mentioned problems need to be solved by a national endeavor for the universal development of fishery. Further, since the fishing using fish pots has come into the spotlight in recent years, the development of good artificial bait will cause the effect of import substitution.

### Technical Solution

The present invention has been made to solve the above-mentioned problems, and it is an object of the present invention to provide artificial bait that can maintain the characteristic of attracting fish without having to be replaced, retain the scent over a long period of time and be manufactured with high productivity without the need to dry, and prevent the devastation of a marine ecosystem by not using a natural bait, and an apparatus and method for manufacturing the artificial bait. The apparatus for manufacturing artificial bait includes a mixing unit, a kneading unit, a cooling part, an extrusion unit, and a vacuum part. The apparatus for manufacturing artificial bait mixes artificial scent with loess, and then mixes mix gum in the mixture of the loess and artificial scent. The apparatus mixes a bonding agent in the mixture of the loess, artificial scent, and the mix gum, and then kneads the bonding agent and the mixture. After that, the apparatus extrudes the mixture below a predetermined temperature, and then vacuum-packs an extruded material to manufacture artificial bait.

According to an embodiment of the present invention, artificial bait includes loess, artificial scent containing the scent of marine products to attract fish and shellfish, dispersion-controlling agent that allows the loess and artificial scent to be dispersed underwater at a constant rate, bonding agent that bonds the loess, the artificial scent, and the dispersion-controlling agent to each other.

The artificial scent may be any one or the mixture of two or more selected from fish flavour, crab flavour, cuttlefish flavour, shrimp flavour, lobster flavour, and anchovy flavour.

The dispersion-controlling agent may be mix gum. The mix gum may be the mixture of two or more selected from guar gum, locust bean gum, carrageenan, and refined guar gum. The mix gum may include 100 parts by weight of guar gum, 80 to 120 parts by weight of locust bean gum, 80 to 120 parts by weight of carrageenan, and 180 to 220 parts by weight of refined guar gum. Preferably, the mix gum may include 20 wt % of guar gum, 20 wt % of locust bean gum, 20 wt % of carrageenan, and 40 wt % of refined guar gum.

The bonding agent may be a wheat flour paste.

The artificial bait may include 100 parts by weight of the loess, 17 to 25 parts by weight of flavour used as the artificial scent, 6 to 20 parts by weight of mix gum used as the dispersion-controlling agent, and 60 to 80 parts by weight of a wheat flour paste used as the bonding agent.

The artificial bait may be vacuum-packed in a packing container so as to have a moisture content in the range of 50 to 80%.

According to another embodiment of the present invention, a method of manufacturing artificial bait includes forming a first intermediate product by mixing flavour with loess, forming a second intermediate product by mixing mix gum in the first intermediate product, kneading the second intermediate product in which a bonding agent is mixed, and extruding the second intermediate product in which a bonding agent is mixed, after the kneading of the second intermediate product in which a bonding agent is mixed.

The flavour may be any one or the mixture of two or more selected from fish flavour, crab flavour, cuttlefish flavour, shrimp flavour, lobster flavour, and anchovy flavour.

The bonding agent may be a wheat flour paste.

It is preferable that the extruding be performed below a temperature of 27° C. The extruding may be performed in a vacuum.

The mix gum may include 100 parts by weight of guar gum, 80 to 120 parts by weight of locust bean gum, 80 to 120 parts by weight of carrageenan, and 180 to 220 parts by weight of refined guar gum.

The method may further include immediately vacuum-packing an extruded material without cooling and cutting the extruded material into a predetermined size, after extruding. The method may further include disinfecting the extruded material with ultraviolet rays, after vacuum-packing of the extruded material.

According to another embodiment of the present invention, an apparatus for manufacturing artificial bait includes a kneading unit kneading the mixture, in which loess, flavour, mix gum, and a wheat flour paste are mixed; and an extrusion unit that is connected to the kneading unit and extrudes the kneaded mixture in a predetermined shape. The extrusion unit is maintained in a vacuum.

The extrusion unit may further include a cooling part for maintaining the kneaded mixture to 27° C. or less.

The apparatus may further include a first mixing unit mixing the flavour with the loess, and a second mixing unit that is connected to the first mixing unit and mixes mix gum in the mixture of the flavour and loess. The second mixing unit may be connected to the kneading unit.

Hereinafter, preferred embodiments of the present invention will be described in detail with reference to accompanying drawings. When reference numerals are used to indicate elements in drawings, it should be understood that like reference numerals refer to like elements even though the elements are shown in different drawings. Further, in the embodiments of the present invention, detailed description of known structures and functions incorporated herein will be omitted when it may make the subject matter of the present invention unclear. In addition, preferred embodiments of the present invention will be described below. However, the present invention is not limited thereto, and may be modified in various ways by those skilled in the art.

First, artificial bait according to an embodiment of the present invention will be described.

Artificial bait according to an embodiment of the present invention includes loess, an artificial scent, a dispersion-controlling agent, and a bonding agent. The artificial bait may include 17 to 25 parts by weight of flavour used as the artificial scent, 6 to 20 parts by weight of mix gum used as the dispersion-controlling agent, and 60 to 80 parts by weight of a wheat flour paste used as the bonding agent, based on 100 parts by weight of the loess. The abovementioned mixing ratio may be slightly different depending on regions, ocean currents, and water temperature. However, it is possible to obtain result in which artificial bait having the abovementioned mixing ratio is most effective for a good catch of fish, from experiments.

The loess, which is a first ingredient of the artificial bait, is obtained by mining natural loess and passing the natural loess through a sieve having a mesh number of about 80. When moisture is added to the loess, the loess has a viscosity. For this reason, the loess can be formed in various shapes. In general, loess contains natural minerals such as calcium oxide, silicon oxide, magnesium, and aluminum, and a lot of mineral. For this reason, loess functions to purify polluted water and to cure a fish disease with an antimicrobial /disinfectant action. Accordingly, loess has been widely used in a general aquafarm. Further, since fish and shellfish instinctively prefer loess, loess has been mixed in bait in the fishing or loess has been scattered around floats of the bait. In addition, the loess also functions in the retention of the artificial scent.

The artificial scent, which is the second ingredient of the artificial bait, is used as a ground bait that has the same scent as the particular fishy smell of fish and shellfish. That is, the artificial scent having the scent of fish and shellfish is used as a ground bait instead of an anchovy, mackerel, sardine, other fish and shellfish, or processed-pulverized by-products. A flavour is used as the artificial scent. The flavour is the artificial scent that is formed by adding various additives to powder of dried fish and shellfish. The flavour may include fish flavour, crab flavour, cuttlefish flavour, shrimp flavour, lobster flavour, anchovy flavour, and the like. Any one or the mixture of two or more selected from the above-mentioned flavours may be used as the artificial scent according to the embodiment of the present invention. That is, a single flavour is used to attract a specific fish species, and one or more single flavours that are mixed in another flavour with a predetermined ratio are used to attract several fish species. The flavour is generally liquid, but may be solid powder.

For example, a shrimp flavour is formed by mixing rape seed oil, triglyceride, soy sauce, DL-tocopherol, and the like to dried shrimp powder. A crab flavour is formed by mixing acetic acid, dimethyl sulfide, butyric acid, propylene glycol, and the like to crab scent.

If the artificial scent such as a flavour is used as the ground bait, the fishy smell and particular scent of fish and shellfish are uniformly retained for a long period of time. For this reason, until the artificial bait is completely exhausted, it is possible to prevent the catch of fish from being decreased as time goes by. Further, the use of the artificial scent can prevent devastation to a marine ecosystem that is caused by the use of fries during the manufacture of natural ground bait such as fish and shellfish, processed-pulverized by-products, and boiled extract. In addition, since the artificial scent emits substantially the same scent as the natural ground bait, substantially the same catch of fish can be maintained. Further, because the scent is retained over a long period of time, the catch of fish is rather to be increased after use for a long time. In addition, if the artificial scent is used, it is possible to omit a troublesome process of cutting the natural ground bait into appropriate sizes. As a result, production is increased and required manpower is decreased. In contrast, if by-products generated in the process of processing caught fish and shellfish are used as the ground bait, it is almost impossible to maintain the freshness of the artificial bait. In addition, since the artificial bait should be vacuum freeze-dried, the manufacturing cost of the artificial bait is increased.

The dispersion-controlling agent, which is a third ingredient of the artificial bait, contains a ground bait. Further, the dispersion-controlling agent is used to control a dispersion rate so that the bait formed of loess is slowly dispersed underwater at a constant rate. If the dispersion-controlling agent is not added to the artificial bait, the artificial bait is quickly dispersed as soon as the artificial bait enters the water. Further, when the rapid ocean current flows, the artificial bait is quickly exhausted. Meanwhile, if a material such as gelatin is added to the artificial bait instead of the flavour, the phase of the artificial bait changes due to a temperature increase during the manufacture of the artificial bait and the artificial bait is coagulated to be reformed. For this reason, the artificial bait is barely dispersed underwater. As a result, the attraction effect of the artificial bait for the fish and shellfish is significantly decreased. Gelatin is an inducing substance of collagen that is protein contained in skins, bones, and the like of animals. Skins, bones, and muscles of animals are processed with acid or alkali and then boiled, so that gelatin is extracted from the skins, bones, and muscles of animals. When gelatin is soaked in liquid, the gelatin absorbs moisture and then expands. When the liquid is heated, the expanded portions of the gelatin are melted and then changed into colloidal sol. Accordingly, the viscosity of the gelatin rises. However, when the liquid is cooled, the expanded portions of the gelatin coagulate and then form gel. Gel can be changed into sol at high temperature. As sol is cooled, sol is changed into gel. The period of formation and the degree of flexibility of gel and sol depend on the temperature and the concentration of protein and saccharide. That is, when gelatin is used as a dispersion-controlling agent and the mixture is compressed in agitating and forming processes during the manufacture of the artificial bait, gelatin ingredients are melted and then changed into sol while the temperature increases. After that, the gelatin ingredients are coagulated to have a high viscosity. For this reason, if gelatin is used as a dispersion-controlling agent, the artificial bait does not have constancy for attracting fish over a period of time and dissolution and dispersion functions that are required for the fish attracting ingredient. As a result, it is not possible to obtain the desired effects.

Accordingly, the applicant manufactured mix gum and applied the mix gum to the catch of fish and shellfish, to solve the above-mentioned problems of gelatin. As a result, it was possible to obtain satisfactory results. The mix gum is formed by mixing refined guar gum, guar gum, carrageenan, and locust bean gum at a predetermined weight ratio.

The refined guar gum and guar gum, which are main raw materials of the mix gum, are polysaccharides obtained by pulverizing seeds of a cyanaposis tetragonolobus, which is a leguminous perennial plant grown in India, Pakistan, and the like. The refined guar gum and guar gum are easily hydrated, and easily form a colloidal solution having a high viscosity even in cold water. Further, since being neutral polymers, the viscous materials of the refined guar gum and guar gum are stable against pH and salts. When the refined guar gum and guar are dispersed in water and two hours have passed, the solution still has a high viscosity. Moreover, after 24 hours have passed, the viscosity increases to it maximum potential.

The carrageenan has a basic structure of galactans that includes repeating units of β-1,3 linked β-D-galactose and α-1,4 linked α-D-galactose. When potassium salts are added to the aqueous solution of the carrageenan, it is possible to form gel and improve the characteristic of the mix gum serving as a thickening agent. The carrageenan having protein reactivity includes negative charges and the protein includes positive charges at a pH level higher than an isoelectric point. For this reason, the carrageenan and protein are bonded to each other by an ion bonding, hydrogen bonding, and electrostatic bonding, and thus form a carrageenan-protein complex. When the complex is formed as described above, the stability of the protein is improved. Further, when existing together with other hydrophilic colloids, the carrageenan is bonded to molecules due to the ion bonding. As a result, the carrageenan can improve the characteristic of the mix gum.

The locust bean gum is a polysaccharide obtained from seeds of a leguminous perennial plant, which is widely grown in Spain, Italy, and Portugal. The locust bean gum is white or yellowish brown powder having a molecular weight of 310,000, and has a granular shape and slight bean smell. The locust bean gum has no effect at a pH level in the range of 3.5 to 9.0, and the viscosity of the locust bean gum deteriorates at a pH level out of the above-mentioned range. The locust bean gum does not have an effect on the viscosity due to the solution of weak common salt, magnesium chloride, and calcium chloride. However, the locust bean gum is salted out by acid, in particular, inorganic acid or oxidizing agent, and the viscosity thereof deteriorates. The surface tension of the locust bean gum is decreased due to heat, pressure, friction, and the like, and the viscosity thereof is partially revealed in cold water. When being formed of gums mixed at a predetermined ratio, mix gum has viscosity and is used as a stabilizer. Further, the mix gum allows bait ingredients to be slowly dispersed underwater at a constant rate, as predetermined time goes by. That is, bait, which contains a ground bait and is formed with loess, should be slowly dispersed underwater to continuously maintain the characteristic of attracting fish. The reason for this is that flavour ingredient emitting particular fishy smell is volatilized when the bait is slowly dispersed underwater. The weight ratio corresponding to the maximum effect of the mix gum will be described in the following examples.

The bonding agent, which is a fourth ingredient of the artificial bait, allows the loess, artificial scent, and molecules of the mix gum to be bonded to each other with a predetermined boning force. A wheat flour paste was used as the bonding agent in the embodiment of the present invention. In this case, it is preferable that a wheat flour paste on the market having a moisture content of about 80% be used. Meanwhile, a wheat flour paste, which is prepared by a general method of appropriately adding moisture to wheat flour or starch and boiling them and then cooled, may be used.

It is preferable that the artificial bait be vacuumpacked in a packing container so as to have a moisture content in the range of 50 to 80%. When the moisture content of the artificial bait is lower than 50%, the artificial bait should undergo a separate drying process. For this reason, the scent of the artificial scent is decreased in the drying process. As a result, there are problems in that the characteristic of attracting fish and shellfish deteriorates and productivity is lowered due to the separate drying process. Further, when the moisture content of the artificial bait is lower than 50%, much time is required until the artificial bait is dispersed in seawater. For this reason, there is a problem in that a dispersion rate of the artificial bait is lowered. Meanwhile, when the moisture content of the artificial bait is higher than 80%, a fluidity of the artificial bait exceeds a critical value. Accordingly, there are problems in that an excessive dispersion rate of the artificial bait occurs in seawater and the artificial bait is deformed or crumbled during storage, handling, and transfer thereof, which reduces the market value. According to the results obtained from the applicant's experiments, when the manufactured artificial bait has been dried by sunlight or is dried by hot wind at a temperature of 40° C. or lower, the artificial scent is volatilized into the air during the drying. As a result, 50% or more of the effect of catching fish was decreased. Since at least 48 hours is required to dry the artificial bait by sunlight or hot wind, there is a problem in productivity. Accordingly, the applicant proposes the invention in which the artificial bait is immediately vacuumpacked without a drying process so as to maintain a predetermined moisture content. Since the artificial bait, which does not undergo a separate drying process so as to have a predetermined moisture content as described above, is put into a fish pot, the fishy smell is emitted in a short time. As a result, it is possible to improve the characteristic of attracting fish.

Next, a method of manufacturing artificial bait according to another embodiment of the present invention will be described.

FIG. 1 is a flowchart illustrating a method of manufacturing artificial bait according to another embodiment of the present invention.

Referring to FIG. 1, a method of manufacturing artificial bait according to another embodiment of the present invention includes a first intermediate product formation process (S10), a second intermediate product formation process (S20), a kneading process (30), an extrusion process (S40), a vacuumpacking process (S50), and an ultraviolet disinfection process (S60). The first intermediate product formation process (S10), the second intermediate product formation process (S20), and the kneading process (S30) should be sequentially performed hereinafter. That is, after a flavour is mixed with loess, mix gum is mixed in this mixture. Then, a bonding agent should be added to the mixture, and the mixture should be kneaded. If the mixing order is changed, there is a problem in that the materials of the mixture are non-uniformly mixed.

In the first intermediate product formation process (S10), a flavour is mixed with loess so as to form a first intermediate product. The first intermediate product is a mixture in which a flavour is mixed with loess. In the first intermediate product formation process (S10), 17 to 25 parts by weight of flavour is mixed with 100 parts by weight of loess for about 4 to 6 minutes, so that a loess mixture for attracting fish and shellfish s formed. In this case, any one of the fish flavour, crab flavour, cuttlefish flavour, shrimp flavour, lobster flavour, and anchovy flavour may be used as the flavour to attract a specific fish species (for example, blue crabs or flatfish). Further, as described above, the mixture of two or more selected from the above-mentioned flavours may be used to attract two or more fish species.

In the second intermediate product formation process (S20), mix gum is mixed in the first intermediate product so as to form a second intermediate product. The second intermediate product is a mixture in which mix gum is further added to the first intermediate product, that is, the mixture of the loess and the flavour. In the second intermediate product formation process (S20), 6 to 20 parts by weight of mix gum is mixed in the first intermediate product for about 4 to 6 minutes. In this case, the mix gum causes the bait to be resolved and separated. The amount of the mix gum is for 3 to 5 days, and the weight ratio of the mix gum may be different depending on the temperature of the seawater, the strength of the ocean currents, and the like. In the second intermediate product formation process (S20), it is preferable in terms of the increase in catch of fish and shellfish that the mix gum include 80 to 120 parts by weight of locust bean gum, 80 to 120 parts by weight of carrageenan, and 180 to 220 parts by weight of refined guar gum, based on 100 parts by weight of guar gum. It is more preferable that the mix gum include 20 wt % of guar gum, 20 wt % of locust bean gum, 20 wt % of carrageenan, and 40 wt % of refined guar gum. This will be described in more detail in the following embodiment and comparative examples.

In the kneading process (S30), a bonding agent is mixed in the second intermediate product and the mixture thereof is kneaded. A wheat flour paste is used as the bonding agent as described above. In the kneading process (S30), 60 to 80 parts by weight of a wheat flour paste is mixed in the second intermediate product. In this case, a wheat flour paste having a moisture content of about 80% is used. In the case when a wheat flour paste is prepared in person, the wheat flour paste should be cooled before use. If the wheat flour paste is used in the kneading without cooling, the flavour emitting fishy smell is volatilized into the air. Accordingly, there is a problem in that the characteristic of attracting fish and shellfish significantly deteriorates. The kneading can be performed for about 8 to 15 minutes, and a screw type kneading device may be used to knead.

In the extrusion process (S40), the mixture kneaded in the kneading process (S30) is compressed at a predetermined pressure and is extruded through an extrusion outlet having a predetermined shape. The extrusion outlet may have various shapes such as circular and polygonal shapes. Since being extruded to have the shape of a long bar, the kneaded mixture may be regularly cut into a predetermined size by a separate cutting process (not shown) so that one piece cut from the kneaded mixture has a weight in the range of about 40 to 60 g. Then, one piece cut from the kneaded mixture may be packed. Meanwhile, the temperature of the extrusion unit may rise up to 70° C. due to the friction between the kneaded mixture and an extruder during the extrusion. In this case, since the guar gum of the kneaded mixture becomes thin, it is not possible to form the mixture in a desired shape. In addition, if the guar gum in the form of sol is cooled and coagulated, the guar gum is not effective and the artificial bait does not disperse in seawater. For this reason, there is a problem in that the characteristic of attracting fish and shellfish deteriorates. The guar gum becomes thin in the form of sol at a temperature of about 40° C., and a separate cooler is required for more stability so that the temperature of the extruder does not exceed 27° C. That is, it is preferable that the extrusion process (S40) be performed at a constant temperature in the range of about 24 to 27° C. For this purpose, as shown in FIG. 2, an extrusion unit 140 of the apparatus for manufacturing the artificial bait, which is separately provided by the applicant, is provided with a cooling part 150 so as to extrude the mixture at a constant temperature. Further, it is preferable that the extrusion process (S40) be performed in a vacuum. If the extrusion process (S40) is not performed not in a vacuum but in the air, air enters the kneaded mixture during the extrusion. For this reason, there is a possibility that the artificial bait is denatured over a short period of time. In addition, the artificial scent is volatilized into the air, which causes a problem in that the characteristic of attracting fish and shellfish deteriorates. To solve these problems, as shown in FIG. 2, an extrusion unit 140, which is separately provided by the applicant, is provided with a vacuum part 160 so as to extrude the mixture in a vacuum. Meanwhile, the applicant manufactured the mixture in the shape of a thin noodle or a grain having a diameter of 4 mm, and separately packed the mixture. As a result, manufacturing cost was increased, so that the effect of import substitution deteriorated. For this reason, fishermen did not prefer the bait manufactured in the shape of a thin noodle or a grain. Further, 50% or more of the effect of catching fish was decreased in the case of when the bait was manufactured in the shape of a thin noodle or a grain.

In the vacuumpacking process (S50), the artificial bait that extruded in the extrusion process (S40) and cut into an appropriate size is packed with packing paper, that is, the artificial bait is vacuumpacked so as to be maintained in a vacuum. When the artificial bait is immediately vacuum-packed without separately cooling after the extrusion process (S40), the moisture content of the artificial bait packed with the packing paper is maintained in the range of about 50 to 80%. The artificial bait vacuum-packed as described above may be stored at a normal temperature. However, it is preferable that the artificial bait vacuum-packed be stored in a cool place if possible. Further, when the artificial bait is actually used, the vacuum packing is removed from the artificial bait. Then, the artificial bait is put into a fish pot and the artificial bait is soaked in seawater. Accordingly, the artificial bait attracts fish and shellfish into the fish pot.

In the ultraviolet disinfection process (S60), the vacuum-packed artificial bait is disinfected by radiating ultraviolet to the artificial bait. Since various bacteria generated in the processes of manufacturing the artificial bait are removed by the ultraviolet disinfection process (S60), it is possible to protect the fish and shellfish ingesting the artificial bait and marine environment. Further, when the artificial bait is delivered from the warehouse after the vacuum packing and ultraviolet disinfection, the artificial bait can be stored in room temperature for available period of six months or more. Accordingly, a user can save money for the artificial bait, and a distributor can save money for the distribution thereof.

A piece of artificial bait can attract fish and shellfish for at least 72 hours due to the control of the dispersion rate of the mix gum, and the loess in the form of fine powder is continuously dispersed in seawater by ocean currents. Accordingly, when being used together with a fish pot, the artificial bait needs to be frequently replaced and can be used for a long time. For this reason, it is possible to significantly reduce troublesomeness in fishing. Further, since the artificial bait can constantly emit volatile fishy smell similar to that of natural bait, it is possible to effectively attract fish and shellfish by using the artificial bait. In addition, the artificial bait is vacuum-packed without cooling. For this reason, when the artificial bait is put into a fish pot, the artificial bait can immediately attract fish and shellfish.

Next, an apparatus for manufacturing artificial bait according to another embodiment of the present invention will be described.

FIG. 2 is a block diagram of an apparatus for manufacturing artificial bait according to another embodiment of the present invention.

Referring to FIG. 2, an apparatus for manufacturing artificial bait according to another embodiment of the present invention includes a first mixing unit 110, a second mixing unit 120, a kneading unit 130, and an extrusion unit 140. Further, the extrusion unit 140 includes a cooling part 150 and a vacuum part 160. An apparatus for manufacturing artificial bait, which is integrally formed with the first mixing unit 110 and the second mixing unit 120, will be described below. However, the first mixing unit 110 and the second mixing unit 120 may be formed so as to be separate from the apparatus for manufacturing the artificial bait, and a mixture formed by the first mixing unit 110 and the second mixing unit 120 can be supplied to the kneading unit 130.

The first mixing unit 110 mixes a flavour with loess. The first mixing unit 110 may be provided with a rotary agitator to perform the mixing. The first intermediate product formation process (S10) of the above-mentioned method of manufacturing the artificial bait is performed in the first mixing unit 110.

The second mixing unit 120 is connected to the first mixing unit 110, and further mixes mix gum in the mixture supplied from the first mixing unit 110. The second mixing unit 120 may also be provided with a rotary agitator so as to perform the mixing, like the first mixing unit 110. The second intermediate product formation process (S20) of the above-mentioned method of manufacturing the artificial bait is performed in the second mixing unit 120.

The kneading unit 130 is connected to the second mixing unit 120. The kneading unit 130 further mixes a bonding agent in the mixture, and then kneads the mixture. A wheat flour paste is used as the bonding agent. The kneading unit 130 may be provided with a screw type kneader, and kneading may be performed in a manner different from the above-mentioned manner.

The extrusion unit 140 is connected to the kneading unit 130, and extrudes the kneaded mixture in a predetermined shape. The extrusion unit 140 is formed to be separate from the kneading unit 130 as shown in FIG. 2, and is separately operated. Although not shown, the extrusion unit and the kneading unit may be integrated to perform the same process at one time. That is, the kneading unit may be composed of a screw type kneader and the kneading and the supplying of the kneaded mixture may be performed at the same time so that the kneaded mixture is extruded through an extrusion outlet. The extrusion outlet of the extrusion unit 140 is a portion through which the kneaded mixture is extruded to the outside, and may have various shapes such as circular and polygonal shapes.

Further, much heat is generated in the extrusion unit 140 due to friction between the kneaded mixture and the extrusion unit 140. When the temperature of the kneaded mixture rises higher than a predetermined temperature, the guar gum forming the mix gum is denatured and hardened. As a result, it is not possible to obtain desired effects as described above. Accordingly, the extrusion unit 140 is further provided with a cooling part 150 so that the temperature of the kneaded mixture is maintained 27° C. or less. For example, the cooling part 150 may surround the extrusion unit 140 having a substantially cylindrical shape, and a separate cooler may be provided in an extrusion line. Meanwhile, the applicant manufactured artificial bait, which has the shape of a thin noodle having a diameter of 4 mm, by using a noodle making machine without a cooling part. As a result, it is possible to obtain the following results. That is, the temperature of the noodle making machine rises higher than 40° C. Further, gelatin, devil's-tongue jelly, and the like are denatured, so that the scent of the artificial scent is denatured. Accordingly, it is very important that the temperature of the extrusion unit 140 is maintained at a predetermined temperature or lower. This allows the artificial bait to be effective even after the extrusion.

In addition, the extrusion unit 140 is further provided with a vacuum part 160 for maintaining a vacuum. For example, the extrusion unit 140 may be formed in a manner such that a vacuum pump is provided in an extrusion line. Accordingly, the apparatus for manufacturing the artificial bait according to another embodiment of the present invention prevents the denaturation of the artificial bait, and maximizes the attraction effect of the artificial bait against the fish and shellfish.

### Advantageous Effects

According to the present invention, since having volatile fishy smell similar to that of natural bait, artificial bait has an attraction effect for fish and shellfish. Further, since a dispersion rate of the artificial bait is controlled at a constant rate, the artificial bait can continuously retain an attraction effect for fish and shellfish over a long period of time without the substitution of a bait.

Further, according to the present invention, since the artificial bait is immediately vacuum-packed without a cooling process, attract scent is retained as it is. For this reason, the artificial bait can have an excellent attraction effect for fish and shellfish.

In addition, according to the present invention, the artificial bait does not use natural fish and shellfish, pulverized materials thereof, by-products, and the like. For this reason, it is possible to prevent the devastation to a marine ecosystem and obtain an environmentally friendly artificial bait.

Further, according to the present invention, after the vacuum packing of the artificial bait is unpacked, it is possible to immediately use the artificial bait. For this reason, it is possible to omit a process of cutting the bait into appropriate sizes like natural bait, and to conveniently handle, store, and use the artificial bait.

Furthermore, according to the present invention, since a separate drying process is not required, it is possible to improve productivity. In addition, since an expensive material such as agar is not used, it is possible to ensure economical efficiency.

### DESCRIPTION OF DRAWINGS

FIG. 1 is a flowchart illustrating a method of manufacturing artificial bait according to an embodiment of the present invention.

FIG. 2 is a block diagram of an apparatus for manufacturing artificial bait according to another embodiment of the present invention.

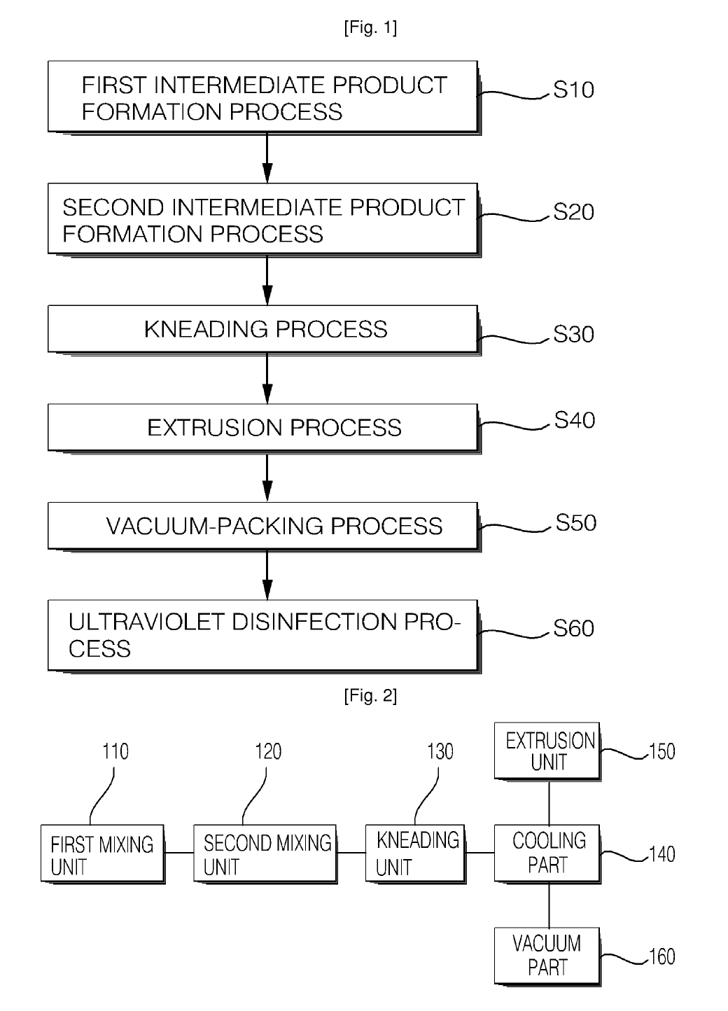

### BEST MODEL

Next, embodiments of artificial bait according to the present invention and comparative examples are compared with each other and examined.

Since three sides of Korea are surrounded by the sea, various fish species inhabiting the sea are different depending on the sea areas. For this reason, different kinds of fish and shellfish, that is, attracting ingredients should be used depending on the kinds of desired fish and shellfish. Further, it was possible to obtain result in which the content of the mix gum in the bait should be changed depending on ocean currents and difference in water temperature on the basis of on the characteristics of each sea area to allow the artificial bait to be effective, from several experiments. In the following embodiments and comparative examples, experiments are performed with seven kinds of bait, that is, natural bait (corresponding to A), three kinds of artificial bait (corresponding to B, C, and D) using gelatin, and three kinds of artificial bait (corresponding to E, F, and G) using mix gum were used in the following embodiments and comparative examples. That is, seven kinds of bait (seventy bait in total) and seventy fish pots were used in the experiments so that the number of each kind of bait was ten. The bait was soaked in seawater for 72 hours. When cryopreserved natural baits were used, the catch of fish was set to 100%. The relative catch of fish with respect to the above-mentioned catch of fish was represented as a percentage in other cases. Further, the experiments were performed at Incheon and Daechon in the west sea area, at Tongyeong and Geoje in the south sea area, and Uljin and Sokcho in the east sea area. Desired fish and shellfish were classified into live-fish, eels, crabs, and octopuses/poulpes. The experimental results are shown below in Table 1.

TABLE 1

| | RESULTS IN EACH AREA (UNIT: %) | | | | | | | | | | | |
|---|---|---|---|---|---|---|---|---|---|---|---|---|
| | WEST SEA AREA | | | | SOUTH SEA AREA | | | | EAST SEA AREA | | | |
| CLASSI- | LIVE- | | | OCTO- | LIVE- | | | OCTO- | LIVE- | | | |
| FICATION | FISH | EELS | CRABS | PUSES | FISH | EELS | CRABS | PUSES | FISH | EELS | CRABS | POULPES |
| A | 100 | 100 | 100 | 100 | 100 | 100 | 100 | 100 | 100 | 100 | 100 | 100 |
| B | 42 | 17 | 24 | 27 | 40 | 28 | 16 | 15 | 17 | 7 | 9 | 41 |
| C | 46 | 19 | 31 | 32 | 43 | 34 | 24 | 17 | 37 | 18 | 11 | 42 |
| D | 45 | 20 | 24 | 31 | 41 | 28 | 22 | 24 | 32 | 15 | 10 | 35 |
| E | 130 | 102 | 105 | 116 | 97 | 126 | 113 | 105 | 103 | 98 | 106 | 124 |
| F | 102 | 112 | 98 | 85 | 116 | 125 | 101 | 99 | 126 | 89 | 96 | 78 |
| G | 99 | 126 | 135 | 91 | 104 | 87 | 120 | 96 | 112 | 136 | 80 | 95 |

* Types and manufacturing methods of bait *
A (first comparative example): natural bait/cryopreservation (mackerel, sardine 40 g)
B (second comparative example): artificial bait/drying (gelatin, agar, crab flavour)
C (third comparative example): artificial bait/drying (gelatin, agar, shrimp flavour)
D (fourth comparative example): artificial bait/drying (gelatin, agar, fish flavour)
E (first example): artificial bait/non-drying/vacuum-packed (mix gum, shrimp flavour)
F (second example): artificial bait/non-drying/vacuum-packed (mix gum, crab flavour)
G (third example): artificial bait/non-drying/vacuum-packed (mix gum, anchovy flavour)
(In this case, the mix gum includes 20 wt % of guar gum, 20 wt % of locust bean gum, 20 wt % of carrageenan, and 40 wt % of refined guar gum)

In the case of the first comparative example A using natural bait, attract scent is quickly decreased as time went by. For this reason, bait was replaced about every 3 hours. As a result, referring to Table 1, it is understood that catch of fish in the first comparative example A is partially larger than that in the embodiments. This result is due to the fact that the bait was replaced by periods. If the first comparative example A remained in seawater without replacing the bait, it is apparent that the catch of fish would be small. In the cases of each of the embodiments E, F, and G, the bait was not replaced until 72 hours have passed. However, it was understood that the catch of fish in the embodiments was similar to that in the first comparative example A using natural bait.

In the cases of the second to fourth comparative examples B, C, and D using gelatin and agar instead of the mix gum, the catch of fish is smaller than half of that in the embodiments E, F, and G. This is analyzed due to the following fact. That is, since being denatured and hardened due to the temperature increases occurring during the extrusion of gelatin, the bait was not sufficiently dispersed in seawater. Meanwhile, due to being very expensive, agar causes high manufacturing cost of the bait. For this reason, the agar has a disadvantage of having low economical efficiency. Further, the particular scent of the second to fourth comparative examples B, C, and D is considerably decreased due to the drying process, which was one reason for the significant deterioration of the characteristic of attracting fish and shellfish.

Meanwhile, in the cases of the embodiments E, F, and G that use mix gum and flavour and are vacuum-packed without the drying process, catch of fish are slightly different from each other in each region and fish species. However, it is understood that the catch of fish in each embodiment is much higher than that in the first comparative example A using natural bait, and those in the second to fourth comparative examples B, C, and D that use gelatin and undergo a drying process. The embodiments were manufactured at a temperature of 27° C. or lower in the extrusion process during the manufacture thereof, due to the cooling part. For this reason, the denaturation/hardening did not occur in the embodiments. Further, since the embodiments were vacuum-packed without the drying process, it was possible to prevent the attract scent from being reduced. Accordingly, since the attraction effect for fish and shellfish was maintained over a long period of time, it was possible to considerably increase catch of fish.

Meanwhile, the content of the mix gum was changed and experiments were then performed. The change in catch of fish is expected from the fact that the dispersion rate of the artificial bait is changed on the basis of the contents of the mix gum. Then, experiments were performed as follows:

Other conditions were kept the same as the conditions in Table 1.

H (fifth comparative example): artificial bait / non-drying / vacuum-packed (mix gum, shrimp flavour)

In this case, the mix gum included 30 wt % of guar gum, 30 wt % of locust bean gum, 30 wt % of carrageenan, and 10 wt % of refined guar gum.

I (sixth comparative example): artificial bait/non-drying/vacuum-packed (mix gum, shrimp flavour)

In this case, the mix gum included 10 wt % of guar gum, 50 wt % of locust bean gum, and 40 wt % of refined guar gum.

In the case of the fifth comparative example, the weight ratios of the guar gum, locust bean gum, and carrageenan were set to be larger than those in the first example. In contrast, the weight ratio of the refined guar gum in the fifth comparative example was set to be small. Further, in the case of the sixth comparative example, the weight ratio of the guar gum was set to be small, and carrageenan was not included. The results in catch of fish of the fifth and sixth comparative examples were shown in Table 2.

TABLE 2

| | RESULTS IN EACH AREA (UNIT: %) | | | | | | | | | | | |
|---|---|---|---|---|---|---|---|---|---|---|---|---|
| | WEST SEA AREA | | | | SOUTH SEA AREA | | | | EAST SEA AREA | | | |
| CLASSI- | LIVE- | | | OCTO- | LIVE- | | | OCTO- | LIVE- | | | |
| FICATION | FISH | EELS | CRABS | PUSES | FISH | EELS | CRABS | PUSES | FISH | EELS | CRABS | POULPES |
| H | 85 | 76 | 50 | 77 | 65 | 53 | 48 | 89 | 35 | 76 | 88 | 66 |
| I | 55 | 59 | 63 | 30 | 88 | 44 | 22 | 36 | 45 | 65 | 48 | 50 |

Since the weight ratio of the refined guar gum is decreased in the fifth comparative example H, it can be understood that catch of fish is generally further decreased as compared to the first example. Meanwhile, since carrageenan is not included in the sixth comparative example I, it can be understood that catch of fish is decreased like the fifth comparative example. Accordingly, it is possible to understand that there is an optimum content of the mix gum for maximizing a dispersion control characteristic. However, the above-mentioned content of the mix gum may be slightly different depending on regions, ocean currents, and water temperature.

### Mode for Invention

### INDUSTRIAL APPLICABILITY

The present invention can be used in fishing industry, fishery, and leisure industry.

1. Artificial bait for attracting fish comprising:
loess;
artificial scent that have scent of marine products to attract fish and shellfish;
dispersion-controlling agent allowing the loess and artificial scent to be dispersed underwater at a constant rate; and
bonding agent for bonding the loess, the artificial scent, and the dispersion-controlling agent to each other.

2. The artificial bait of claim 1, wherein the artificial scent is any one or the mixture of two or more selected from fish flavour, crab flavour, cuttlefish flavour, shrimp flavour, lobster flavour, and anchovy flavour.

3. The artificial bait of claim 1, wherein the dispersion-controlling agent is mix gum.

4. The artificial bait of claim 3, wherein the mix gum is the mixture of two or more selected from guar gum, locust bean gum, carrageenan, and refined guar gum.

5. The artificial bait of claim 3, wherein the mix gum includes 100 parts by weight of guar gum, 80 to 120 parts by weight of locust bean gum, 80 to 120 parts by weight of carrageenan, and 180 to 220 parts by weight of refined guar gum.

6. The artificial bait of claim 3, wherein the mix gum includes 20 wt % of guar gum, 20 wt % of locust bean gum, 20 wt % of carrageenan, and 40 wt % of refined guar gum.

7. The artificial bait of claim 1, wherein the bonding agent is a wheat flour paste.

8. The artificial bait of claim 1, wherein the artificial bait includes 100 parts by weight of the loess, 17 to 25 parts by weight of flavour used as the artificial scent, 6 to 20 parts by weight of mix gum used as the dispersion-controlling agent, and 60 to 80 parts by weight of a wheat flour paste used as the bonding agent.

9. The artificial bait of claim 1, wherein the artificial bait is vacuum-packed in a packing container so as to have a moisture content in the range of 50 to 80%.

10. A method of manufacturing artificial bait, the method comprising:
forming a first intermediate product by mixing flavour with loess;
forming a second intermediate product by mixing mix gum in the first intermediate product;
kneading the second intermediate product in which a bonding agent is mixed; and
extruding the second intermediate product in which a bonding agent is mixed, after the kneading of the second intermediate product in which a bonding agent is mixed.

11. The method of claim 10, wherein the flavour is any one or the mixture of two or more selected from fish flavour, crab flavour, cuttlefish flavour, shrimp flavour, lobster flavour, and anchovy flavour.

12. The method of claim 10, wherein the bonding agent is a wheat flour paste.

13. The method of claim 10, wherein the extruding is performed at a temperature of 27° C. or lower.

14. The method of claim 10, wherein the extruding is performed in a vacuum.

15. The method of claim 10, wherein the mix gum includes 100 parts by weight of guar gum, 80 to 120 parts by weight of locust bean gum, 80 to 120 parts by weight of carrageenan, and 180 to 220 parts by weight of refined guar gum.

16. The method of claim 10, further comprising:
immediately vacuum-packing an extruded material without cooling and cutting the extruded material into a predetermined size, after extruding.

17. The method of claim 16, further comprising:
disinfecting the extruded material with ultraviolet rays, after the vacuum-packing of the extruded material.

18. An apparatus for manufacturing artificial bait, the apparatus comprising:
a kneading unit kneading the mixture, in which loess, flavour, mix gum, and a wheat flour paste are mixed; and
an extrusion unit that is connected to the kneading unit and extrudes the kneaded mixture in a predetermined shape,
wherein the extrusion unit is maintained in a vacuum.

19. The apparatus of claim 18, wherein the extrusion unit further includes a cooling part for maintaining the temperature of the kneaded mixture at about 27° C. or lower.

20. The apparatus of claim 18, further comprising:
a first mixing unit mixing the flavour with the loess; and
a second mixing unit that is connected to the first mixing unit and mixes mix gum in the mixture of the flavour and loess,
wherein the second mixing unit is connected to the kneading unit.
